(19) United States
(12) Patent Application Publication
(10) Pub. No.: US 2010/0229817 A1
(43) Pub. Date: Sep. 16, 2010

(54) AIR INTAKE DUCT STRUCTURE

(75) Inventor: Yoshiki Hirai, Toyota-Shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/719,363

(22) Filed: Mar. 8, 2010

(30) Foreign Application Priority Data
Mar. 11, 2009 (JP) JP2009-058278

(51) Int. Cl. F02M 35/104

(52) U.S. Cl. 123/184.21

(57) ABSTRACT

There is provided an air intake duct structure comprising a first outer air intake duct member, a second outer air intake duct member, and an inner air intake duct member. The first outer air intake duct member is fastened with the inner air intake duct member by a first fastening device, and the second outer air intake duct member is fastened with the inner air intake duct member by a second fastening device to construct an integrally assembled structure. The fastened first outer air intake duct member and the inner air intake duct member constitute a first air intake duct, and the fastened second outer air intake duct member and the inner air intake duct member constitute a second air intake duct. The first and second air intake ducts allow air to pass therethrough.

### BACKGROUND OF THE INVENTION

This Application claims priority of Japanese Patent Application No. 2009-058278 filed on Mar. 11, 2009, which is incorporated herein by reference.

### FIELD OF THE INVENTION

The present invention relates to an air intake duct structure for allowing intake air to pass therethrough, and more particularly to an air intake duct structure to be used for an automotive vehicle to introduce the intake air to an engine through an air cleaner.

### DESCRIPTION OF THE RELATED ART

As an air intake duct structure of this kind, there has so far been known an air intake duct structure, for example, by Japanese Patent Publication No. 74426/2003, and comprising an intake duct, an opening/closing valve, and an actuator. The intake duct is formed with a first duct passageway having a fixed cross section area, and a second duct passageway having a variable cross section area varied in response to the output of the engine. The opening/closing valve is provided in the second duct passageway, and the actuator is adapted to actuate the opening/closing valve. The air intake duct structure thus constructed can obtain a necessary intake air amount in the second duct passageway with the variable cross section area varied in response to the output of the engine, while can make small the variable cross section area to reduce intake air noises at a level as small as possible when the engine needs a small amount of the intake air passing through the second duct passageway.

The known air intake duct structure comprises outer and inner members divided right and left in the longitudinal direction of the air intake duct structure and integrally fitted and combined with each other. The known air intake duct structure has a separation wall extending in the longitudinal direction of the intake air duct structure and defining part of the first and second duct passageways. The inner member of the intake air duct has a plurality of projections to be securely connected with an air cleaner by means of fixing members such as a bolt and the like.

Other than the above conventional air intake duct structure is proposed another conventional air intake duct structure of a dual-type, which is shown in FIG. 26. The dual-type air intake duct structure comprises first and second air intake ducts 5 and 10. The first air intake duct 5 includes an air inlet 1, a first air outlet 3 connected with an air cleaner 2, and a first air intake passageway portion 4 to pass the intake air from the air inlet 1 to the first air outlet 3. The first air intake passageway portion 4 includes an annular male boss member 6. The second air intake duct 10 includes an annular female boss member 7, a second air outlet 8 to be connected with the air cleaner 2, and a second air intake passageway portion 9 to pass the intake air to the second air outlet 8. The annular male boss member 6 of the first air take passageway portion 4 is received in the annular female boss member 7 to pass the intake air from the first air intake passageway portion 4 to the second air intake duct 10.

In the above dual-type air intake duct structure, the first air intake duct 5 is further provided with a first resonator 11 to reduce the intake noises generated in the first air take passageway portion 4, and the second air intake duct 10 is further provided with a second resonator 12 to reduce the intake noises generated in the second air take passageway portion 9. In addition, an annular member 13 made of an elastic material such as sponge is received in a gap between the outer peripheral surface of the annular male boss member 6 and the inner peripheral surface of the annular female boss member 7 to prevent not only the intake air from escaping through the gap but also the members 6 and 7 from physically interfering with each other.

Also, the first and second air intake ducts 5 and 10 are attached to a radiator support member 16 with a bolt 15 screwed into a hole formed in an attachment member 14 of the first air intake duct 5, and with a bolt 18 screwed into a hole formed in an attachment member 17 of the second air intake duct 10.

In the conventional air intake duct structure disclosed in Japanese Patent Publication No. 74426/2003, the outer and inner members are integrally fitted and combined with each other; however, the inner member is attached to part of the air cleaner by the fixing members and thus has a free end at its intake side. This means that the inner member is supported by the air cleaner in a cantilever fashion. The air intake duct structure is therefore susceptible to vibrations generated to the outer and inner members and leads to the inner member and the air cleaner being apt to be loosened if the air intake duct structure has a relatively long length. It is therefore difficult to apply the relatively long air intake duct structure previously mentioned to the engine.

The fact that the known air intake duct structure comprises the outer and inner members integrally fitted and combined with each other, and the separation wall extending in the longitudinal direction of the intake air duct structure and defining part of the first and second duct passageways, results in the fact that if the air intake duct structure has first and second duct passageways juxtaposed and having respective circular cross sections, the air intake duct structure is obliged to have a relatively large fitted portion provided on the outer and inner members so that the outer and inner members are incompletely fitted and combined with each other, thereby making it difficult for the air intake duct structure to be applied to the engine.

The above-described dual-type air intake duct structure encounters such a problem that not only the workability for the assembling operation but also the production efficiency are deteriorated to a relatively low level, because the first and second air intake ducts 5 and 10 which are formed independently and separately attached to the radiator support 16 by the bolts 15 and 18.

In addition, the dual-type air intake duct structure comprises a multiplicity of components such as the first intake duct 5, the second air intake duct 10, the annular sponge member 13, and the bolts 15 and 18, leads to the fact that the dual-type air intake duct structure has no advantages in the aspects of the production efficiency and costs as a result of many components used in the air intake duct structure. Further, the second air intake duct 10 coupled with the first air intake duct 5 through the annular sponge member 13 results in the second air intake duct 10 being substantially swung in a horizontal direction with respect to an automotive vehicle due to the vibrations generated therein. Therefore, the space in an engine room for allowing the second air intake duct 10 to swing is required, thereby leading to giving rise to a dead space in the engine room.

### SUMMARY OF THE INVENTION

The present invention has been made to solve the foregoing problems encountered by the conventional air intake duct structures.

It is, therefore, an object of the present invention to provide an air intake duct structure having a high stiffness.

It is another object of the present invention to provide an air intake duct structure having an excellent workability of the assembling operation and an enhanced production efficiency.

According to the present invention, there is provided an air intake duct structure for passing intake air therethrough, comprising: a first outer air intake duct member having a first opening formed therein to extend in the longitudinal direction thereof; a second outer air intake duct member having a second opening formed therein to extend in the longitudinal direction thereof, an inner air intake duct member having third and fourth openings both formed therein to extend in the longitudinal direction thereof, the inner air intake duct member being juxtaposed between the first and second outer air intake duct members in such a manner that the third opening thereof is opposed to the first opening of the first outer air intake duct member and the fourth opening thereof to the second opening of the second outer air intake duct member; a first fastening device for fastening the first outer air intake duct member to the inner air intake duct member; and a second fastening device for fastening the second outer air intake duct member with the inner air intake duct member; wherein the first and second outer air intake duct members are fastened with the inner air intake duct member, respectively, by means of the first and second fastening device to form first and second air intake ducts for passing the intake air therethrough.

In the air intake duct structure, the inner air intake duct member is integrally formed, and the first and second outer air intake duct members are fastened with the inner air intake duct member to construct an integrally assembled structure. The integrally assembled structure leads to the fact that the air intake duct structure according to the present invention has a high stiffness in comparison with the conventional dual-type air intake duct structure in which separate air intake ducts are assembled to each other with an elastic material being disposed between the separate air intake ducts.

The air intake duct structure according to the present invention has the high stiffness as described above so that the swing range of the air intake duct structure swung by the vibrations generated in an automotive vehicle can remarkably become small, resulting in no wider space in an engine room required for the air intake duct structure.

In comparison with the conventional dual-type air intake duct structure, it will be appreciated that the inner air intake duct member integrally formed in the present invention can omit the elastic material i.e., the annular sponge member used in the conventional dual-type air intake duct structure, and the number of components such as fixing members used for the air intake duct structure according to the present invention can be decreased. Therefore, an excellent workability of the assembling operation and an enhanced production efficiency can be realized in the air intake duct structure according to the present invention.

According to the present invention, it is preferable that the first outer air intake duct member include a first passageway wall forming the first opening in the longitudinal direction of the first outer air intake duct, the second outer air intake duct member includes a second passageway wall forming the second opening in the longitudinal direction of the second outer air intake duct member, the inner air intake duct member includes a third passageway wall forming the third opening in the longitudinal direction of the inner air intake duct member and a fourth passageway wall forming the fourth opening in the longitudinal direction of the inner air intake duct member, the first fastening device is provided on the first and third passageway walls, and the second fastening device is provided on the second and fourth passageway walls.

In the air intake duct structure, the first fastening device can be constituted by the hooks formed on the outer wall portion of the first passageway wall and the hooks formed on the outer wall portion of the third passageway wall, and the second fastening device can be constituted by the hooks formed on the outer wall portion of the second passageway wall and the hooks formed on the outer wall portion of the fourth passageway wall. The hooks of the first passageway wall are respectively engaged with the hooks of the third passageway wall to fasten the first outer air intake duct member with the inner air intake duct member, and the hooks of the second passageway wall are respectively engaged with the hooks of the fourth passageway wall to fasten the second outer air intake duct member with the inner air intake duct member.

As the first and second fastening devices are constituted, respectively, by the hooks formed on the outer wall portion of each passageway wall, the fastening of the first and second outer air intake duct members to the inner air intake duct member by the hooks can be easily carried out outside the respective passageway walls. As a result, the workability of fastening operation becomes improved, and then the production efficiency is enhanced.

Alternatively, the first fastening device can be constituted by a plurality of hooks formed on the inner wall portion of the first passageway wall and a plurality of hooks formed on the inner wall portion of the third passageway wall, the second fastening device can be constituted by a plurality of hooks formed on the inner wall portion of the second passageway wall and a plurality of hooks formed on the inner wall portion of the fourth passageway wall. The hooks of the first passageway wall are respectively engaged with the hooks of the third passageway wall to fasten the first outer air intake duct member with the inner air intake duct member, and the hooks of the second passageway wall are respectively engaged with the hooks of the fourth passageway wall to fasten the second outer air intake duct member with the inner air intake duct member.

As the first and second fastening devices are constituted, respectively, by hooks formed on the inner wall portion of each passageway wall, the fastening of the first and second outer air intake duct members to the inner air intake duct member by the hooks can be easily carried out inside the respective passageway walls. As a result, the outer shape of the air intake duct structure is downsized to reduce the space occupied thereby in addition to an excellent workability of the assembling operation and an enhanced production efficiency obtained by easily fastening the first and second outer air intake duct members to the inner air intake duct member with the hooks.

According to the present invention, it is preferable that the first air intake duct be formed to have an inlet port allowing the intake air to be introduced therethrough, an inflow opening formed in the third passageway wall in the vicinity of the inlet port, and a first outlet port allowing the intake air to be discharged therethrough, while the second air intake duct is formed to have an inflow port communicated to the inflow opening, and a second outlet port allowing the intake air to be discharged to the second air intake duct from the first air intake duct through the inflow opening and inflow port.

It will be appreciated that the air intake duct structure thus constructed contributes to the higher stiffness thereof because the first and second air intake ducts are firmly connected without using the elastic material of the conventional dual-type air intake duct structure

According to the present invention, it is preferable that one of the first outer air intake duct member, the second outer air intake duct member, and the inner air intake duct member be provided with an attachment member arranged in the vicinity of the inlet port.

Therefore, the air intake duct structure can be fixedly and certainly attached to the radiator support by fixing the attachment member to the radiator support with fixing members. This means that the excellent workability of the assembling operation and the enhanced production efficiency are further improved.

According to the present invention, it is preferable that the first outer air intake duct member include a first resonator mounted on the outer wall portion of the first passageway wall for reducing intake noises generated in the first intake duct, and that the second outer air intake duct member include a second resonator mounted on the outer wall portion of the second passageway wall for reducing intake noises generated in the second intake duct.

The first and second resonators can effectively reduce the intake noises generated in the first and second intake ducts by the vibration in the intake air passing through the first and second air intake ducts.

In the present invention, while the first and second resonators are mounted on the first and second outer air intake duct members, respectively, the vibration in an automotive vehicle has less adverse affect on the first and second resonators and the first and second ducts because the air intake duct structure according to the present invention has the high stiffness to suppress respective swing ranges thereof. If the first resonator and the first outer air intake duct member are integrally produced, and the second resonator and the second outer air intake duct member are integrally produced, respectively, through a molding such as an injection molding, it is not required to produce the resonators and outer air intake duct members separately. In this case, the enhanced production efficiency for producing the components such as the resonators and outer air intake duct members, and thus the excellent workability in assembling operation are further improved.

According to the present invention, the air intake duct structure can be provided having not only the high stiffness, but also the excellent workability in assembling operation and the enhanced production efficiency.

### BRIEF DESCRIPTION OF DRAWINGS

The features and advantageous effects of an air intake duct structure according to the present invention will more clearly be understood from the following description taken in conjunction with the accompanying drawings, in which:

FIG. 1 is a plan view of an air intake duct structure according to a first embodiment, which is attached to an air cleaner and radiator support;

FIG. 2 is a side view of the air intake duct structure shown in FIG. 1, which is attached to the air cleaner and radiator support;

FIG. 3 is a plan view of the air intake duct structure according to the first embodiment but omitting air cleaner and radiator support;

FIG. 4 is a front view of the air intake duct structure shown in FIG. 3;

FIG. 5 is a side view of the air intake duct structure shown in FIG. 3;

FIG. 6 is a side view of a first outer air intake duct member forming part of the air intake duct structure shown in FIG. 5;

FIG. 7 is a cross-sectional view taken along A-A line in FIG. 6;

FIG. 8 is a side view of a second outer air intake duct member forming part of the air intake duct structure shown in FIG. 5;

FIG. 9 is a cross-sectional view taken along B-B line in FIG. 8;

FIG. 10 is a side view of an inner air intake duct member forming part of the air intake duct structure shown in FIG. 5;

FIG. 11 is a cross-sectional view taken along C-C line in FIG. 10;

FIG. 12 is an exploded side view of the air intake duct structure shown in FIG. 5;

FIGS. 13A, 13B, and 13C are each a cross-sectional view of a first fastening device forming part of the air intake duct structure according to the first embodiment for illustrating the engagement state of hooks thereof;

FIGS. 14A, 14B, and 14C are each a cross-sectional view of another first fastening device forming part of the air intake duct structure according to the first embodiment for illustrating the engagement state of hooks thereof

FIGS. 15A, 15B, and 15C are each a cross-sectional view of a further first fastening device forming part of the air intake duct structure according to the first embodiment for illustrating the engagement state of hooks thereof;

FIG. 16 is a plan view of an air intake duct structure according to a second embodiment, which is attached to an air cleaner and radiator support;

FIG. 17 is a side view of the air intake duct structure shown in FIG. 16;

FIG. 18 is a plan view of the air intake duct structure according to the second embodiment but omitting the air cleaner and radiator support;

FIG. 19 is a front view of the air intake duct structure shown in FIG. 18;

FIG. 20 is a side view of the air intake duct structure shown in FIG. 19;

FIG. 21 is a side view of a first outer air intake duct member forming part of the air intake duct structure shown in FIG. 20;

FIG. 22 is a cross-sectional view taken along D-D line in FIG. 21;

FIG. 23 is a side view of a second outer air intake duct member forming part of the air intake duct structure shown in FIG. 20;

FIG. 24 is a cross-sectional view taken along E-E line in FIG. 23;

FIG. 25 is an exploded side view of the air intake duct structure of the second embodiment according to the present invention; and

FIG. 26 is an exploded side view of the conventional dual-type air intake duct structure.

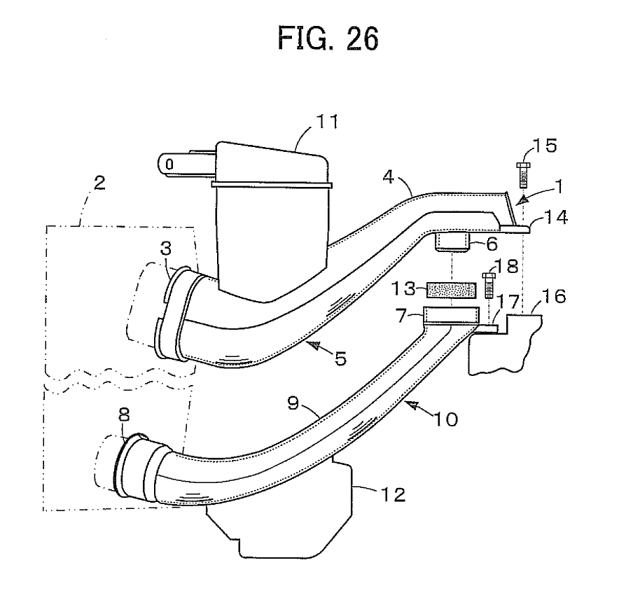

### DESCRIPTION OF THE PREFERRED EMBODIMENTS

The air intake duct structures according to embodiments of the present invention will be described hereinafter in more detail with reference to the drawings.

### First Embodiment

The structure of the air intake duct structure according to the first embodiment of the present invention will be explained hereinafter.

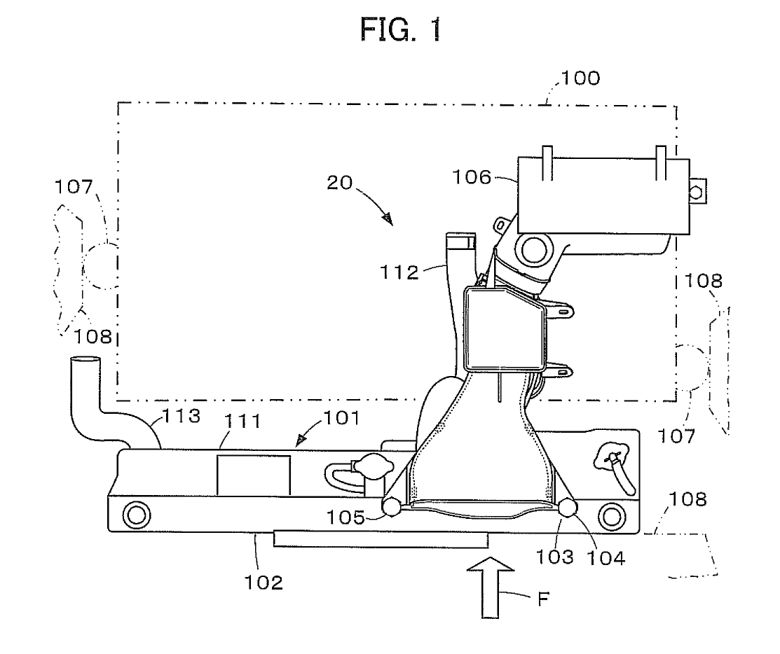

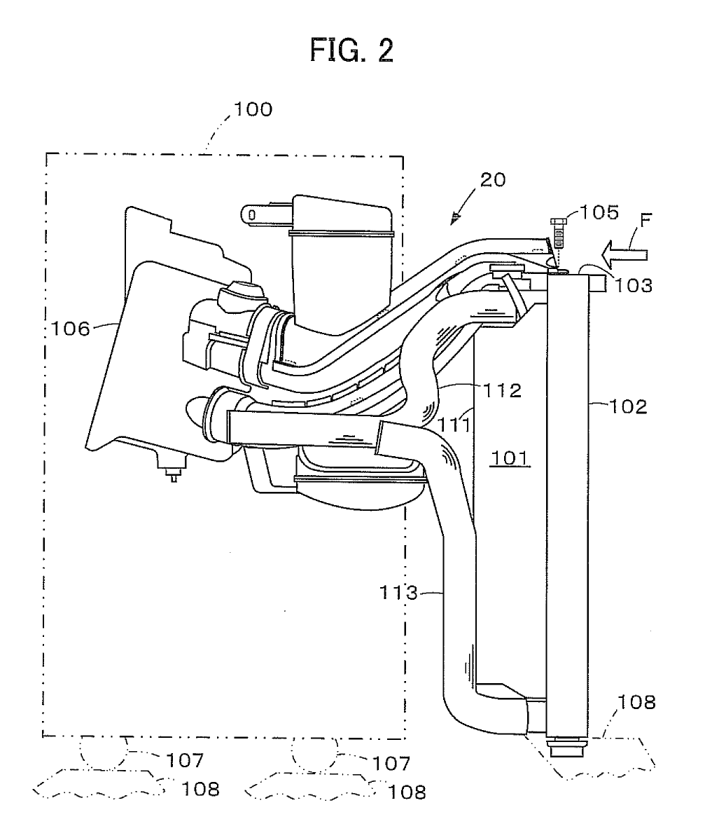

Referring to FIGS. 1 and 2, the reference numerals 100, 101 and 102 indicate an engine, a radiator, and a radiator support, respectively. The radiator 101 is supported on the engine 100 by the radiator support 102. The air intake duct structure 20 is attached at one end portion by bolts 104 and 105 to the upper portion 103 of the radiator support 102, and coupled at the other end portion to an air cleaner 106.

The air intake duct structure 20 thus constructed can introduce comparatively cool air to the engine 100 through the air cleaner 106 in the direction as indicated by an arrow F in FIG. 2.

The engine 100 is mounted on the body 108 of an automotive vehicle by means of an engine mount 107. The radiator 101 comprises a body 111, an upper radiator hose 112, and a lower radiator hose 113. Both of the upper radiator hose 112 and the lower radiator hose 113 are connected to the engine 100 to allow the cooling water to be circulated between the engine 100 and the radiator body 111. The radiator 101 is retained on the vehicle body 108 by the radiator support 102.

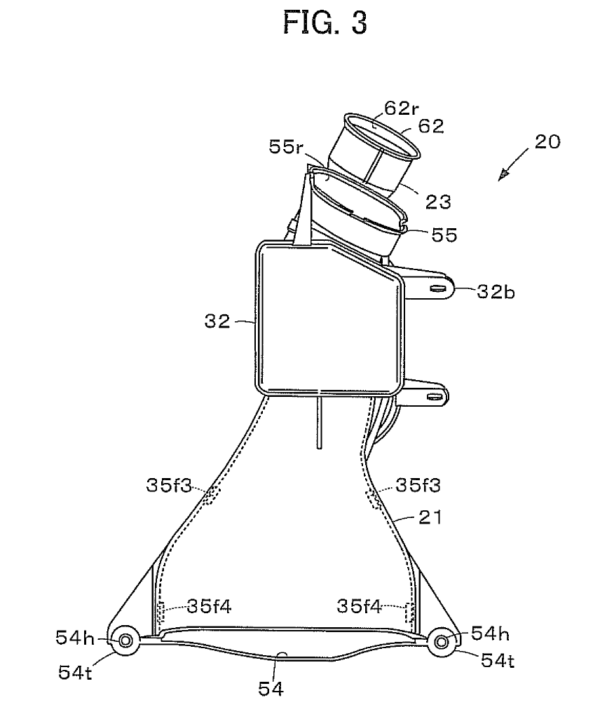

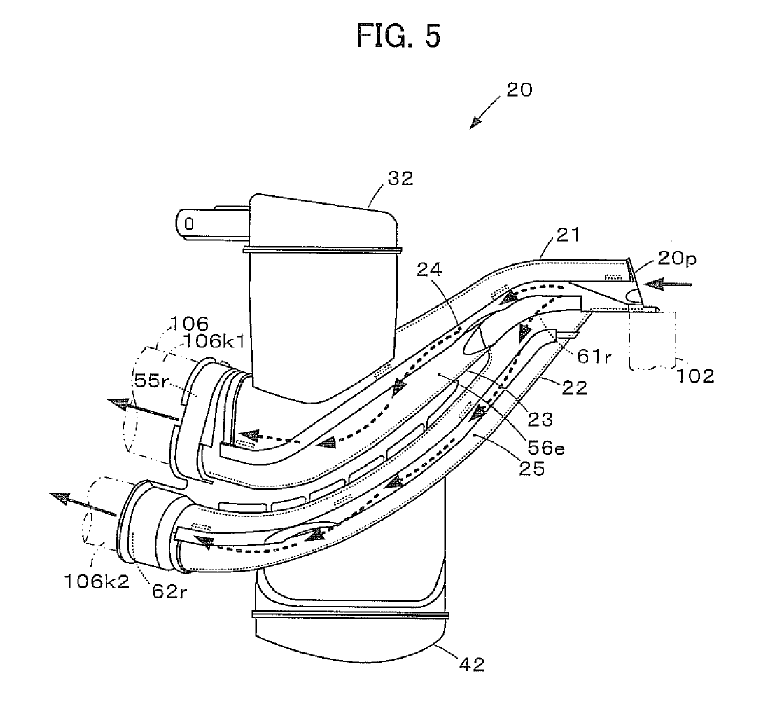

The air intake duct structure 20 is shown in FIGS. 3 to 5, and comprises a first outer air intake duct member 21, a second outer air intake duct member 22, and an inner air intake duct member 23. The first outer air intake duct member 21 and the upper portion of the inner air intake duct member 23 are connected with each other to constitute a first air intake duct 24, while the second outer air intake duct member 22 and the lower portion of the inner air intake duct member 23 are also connected with each other to constitute a second air intake duct 25. The intake air is divided into the air intake ducts 24 and 25 as shown by the arrows and dotted lines in FIG. 5 when the intake air is introduced into the duct structure 20.

With reference to FIGS. 3, 6 and 7, the first outer air intake duct member 21 includes a duct element 31 and a first resonator 32 integrally fitted and combined together. The components constituting the first outer air intake duct member 21 can be made of a plastic material, and thus produced, for example, through a molding such as an injection molding, a blow molding, or the like.

The duct element 31 has an inlet portion 33 allowing air to be introduced therethrough, a coupling portion 34 to be coupled to the inner air intake duct member 23, and a passageway portion 35 extending between the inlet portion 33 and the coupling portion 34 to pass the intake air from the inlet portion 33 to the coupling portion 34.

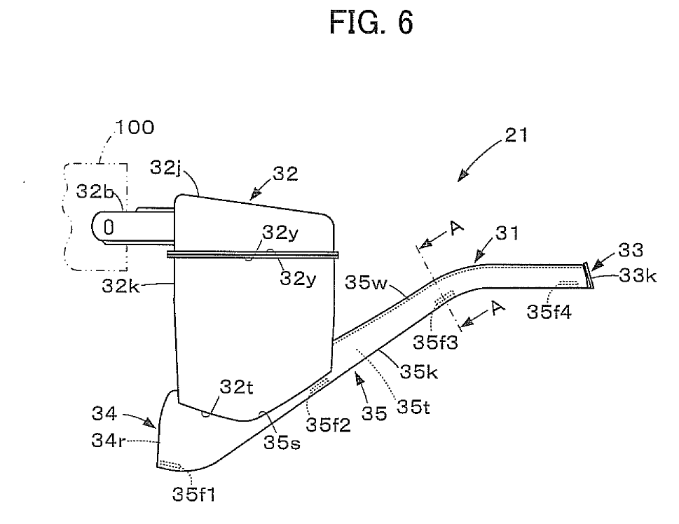

As best shown in FIG. 6, the inlet portion 33 has an inlet port 33k opened in the direction perpendicular to the direction along which the intake air flows so that the intake air can be introduced from the inlet port 33k into the passageway portion 35.

The coupling portion 34 has a communication port 34r opened in the direction perpendicular to the direction along which the intake air flows. The intake air passes through the communication port 34r to the air cleaner 106.

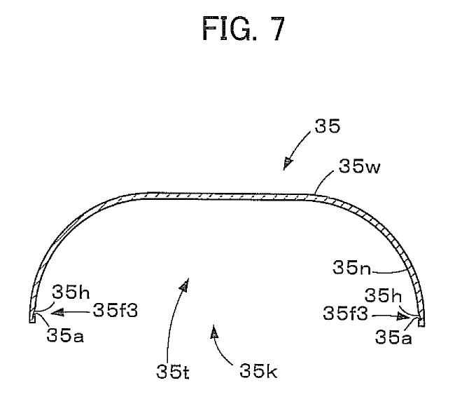

The passageway portion 35 has a first opening 35k downwardly opened and an air intake passageway 35t formed therein, the first opening 35k extending in the longitudinal direction of the first air intake duct 24, viz., in the direction along which the intake air flows therein. As best shown in FIG. 7, the air intake passageway 35t is formed by a passageway wall 35w of the duct element 31 having a cross section in a roughly arcuate shape in the plane perpendicular to the direction along which the intake air flows. In the air intake passageway 35t, the inlet port 33k of the inlet portion 33 is held in communication with the communication port 34r of the coupling portion 34 as shown in FIG. 6. While the passageway wall 35w is explained to have a cross section in a roughly arcuate shape, it may have any cross section having a shape formed by part of square or other polygonal shapes according to the present invention.

On the inner wall portion of the passageway wall 35w in the vicinity of the first opening 35k, there are provided a plurality of pairs of hooks 35f1, 35f2, 35f3, and 35f4 in a spaced relationship with one another at a certain interval in the direction along which the intake air flows. The hooks of each pair are opposed to each other with the first opening 35k being interposed therebetween. It is noted that the respective pairs of hooks 35f1, 35f2, 35f3, and 35f4 constitute part of the first fastening device in the present invention.

As best shown in FIG. 7, each of the hooks 35f3 has a notch 35h dented from the inner wall portion 35n of the passageway wall 35w and a jaw-like ledge 35a formed next to the notch 35h. Each of the hooks 35f1, 35f2, and 35f4 is formed similarly to the hook 35f3. The notch 35h and the jaw-like ledge 35a previously mentioned will become apparent as the description proceeds.

The duct element 31, as best shown in FIG. 6, has a support surface 35s formed therein by removing part of the passageway wall 35w to support the first resonator 32 on the support surface 35s. Thus, the duct element 31 and the first resonator 32 are integrally fitted and combined in such a manner that the first resonator 32 is supported on the support surface 35s.

The first resonator 32 includes a lower resonator element 32k, an upper resonator element 32j, and a bracket 32b provided on the upper resonator element 32j. The bracket 32b serves to fix the first resonator 32 to the engine 100. The lower resonator element 32k has an abutment surface 32t to be held in contact with the support surface 35s. The lower resonator element 32k and the duct element 31 are integrally fitted and combined with the abutment surface 32t and support surface 35s being held in contact with each other. Each of the upper end of the lower resonator element 32k and the lower end of the upper resonator element 32j has a welding surface 32y. The lower resonator element 32k and upper resonator element 32j are welded together at their surfaces 32y.

The first resonator 32 is formed with a cavity which is held in communication with the air intake passageway 35t of the passageway portion 35 so that the noises generated by the oscillation of the intake air passing through the air intake passageway 35t can be reduced with the noises resonated in harmony within the cavity

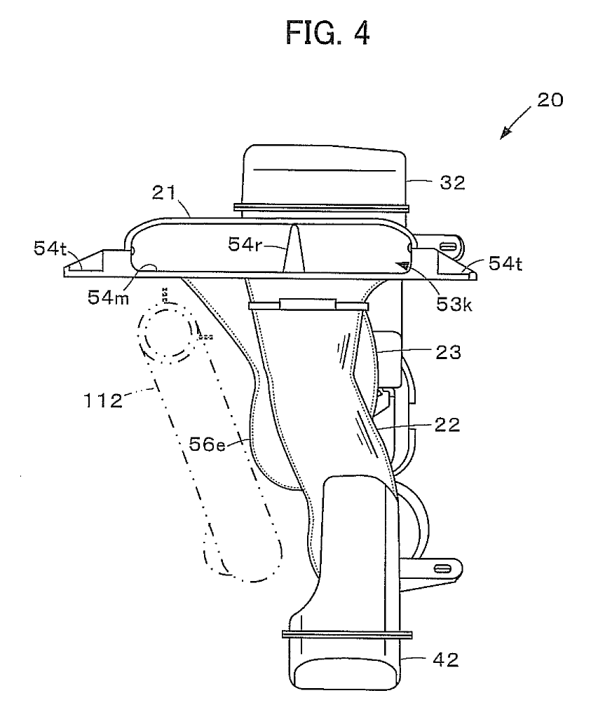

Referring to FIGS. 4, 8 and 9, the second outer air intake duct member 22 includes a duct element 41 and a second resonator 42 integrally fitted and combined together. The second outer air intake duct member 22 can be made of a plastic material, and thus produced, for example, through a molding such as an injection molding, a blow molding, or the like in the same way as the first outer air intake duct member 21.

The duct element 41 has an inflow portion 43 allowing the intake air to be introduced therethrough, a coupling portion 44 to be coupled to the inner air intake duct member 23, and a passageway portion 45 extending between the inflow portion 43 and the coupling portion 44 to pass the intake air from the inflow portion 43 to the coupling portion 44.

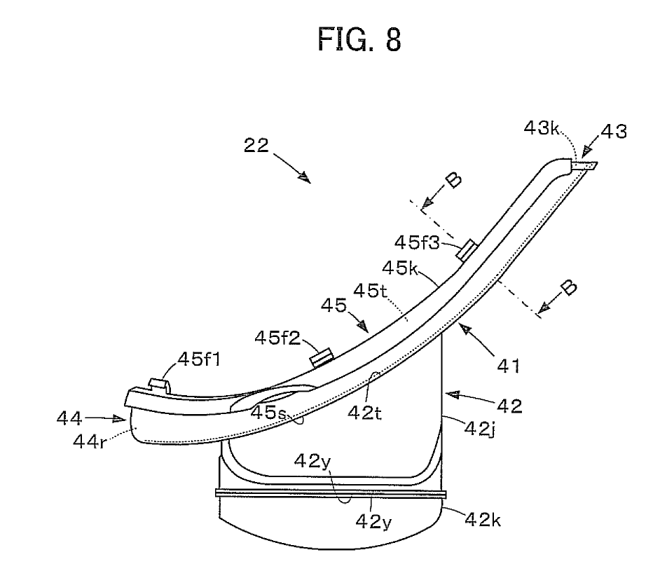

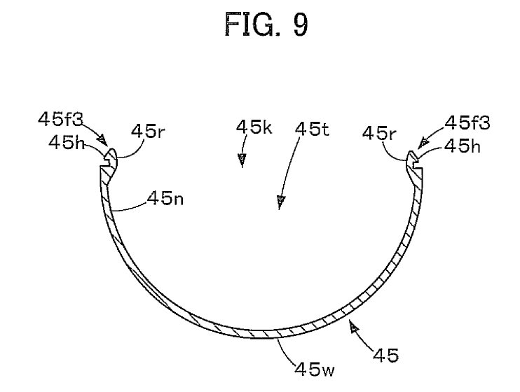

As best shown in FIGS. 8 and 9, the inflow portion 43 has an inflow port 43k opened in the direction perpendicular to the direction along which the intake air flows, so that the intake air can flow from the inflow port 43k into the passageway portion 45.

The coupling portion 44 has a communication port 44r opened in the direction perpendicular to the direction along which the intake air flows. The intake air passes through the communication port 44r to the air cleaner 106.

The passageway portion 45 has a second opening 45k upwardly opened and an air intake passageway 45t formed therein, the second opening 45k extending in the longitudinal direction of the second air intake duct 25, viz., in the direction along which the intake air flows therein. As shown in FIG. 9, the air intake passageway 45t is formed by a passageway wall 45w of the duct element 41 having a cross section in a roughly arcuate shape in the plane perpendicular to the direction along which the intake air flows. In the air intake passageway 45t, the inflow port 43k of the inflow portion 43 is held in communication with the communication port 44r of the coupling portion 44. While the passageway wall 45w is explained to have a cross section in a roughly arcuate shape, it may have any cross section having a shape formed by part of square or other polygonal shapes according to the present invention.

On the inner wall portion of the passageway wall 45w in the vicinity of the second opening 45k, there are provided a plurality of pairs of hooks 45f1, 45f2, 45f3, and 45f4 in a spaced relationship with one another at a certain interval in the direction along which the intake air flows. The hooks of each pair are opposed to each other with the second opening 45k being interposed therebetween. The respective hooks 45f1, 45f2, 45f3, and 45f4 constitute part of the second fastening device in the present invention.

As best shown in FIG. 9, each of the hooks 45f3 has a bulge 45r protruded inwardly, viz., toward the opening 45k from the inner wall portion 45n of the passageway wall 45w, and an eave-like ledge 45h protruded outwardly and integrally formed with the bulge 45r. Each of the hooks 45f1 and 45f2 is formed similarly to the hook 45f3.

The duct element 41, as best shown in FIG. 8, has a support surface 45s formed therein by removing part of the passageway wall 45w to support the second resonator 42 on the support surface 45s. Thus, the duct element 41 and the second resonator 42 are integrally fitted and combined in such a manner that the second resonator 42 is supported on the support surface 45s.

The second resonator 42 includes an upper resonator element 42j and a lower resonator element 42k. The upper resonator element 42j has an abutment surface 42t to be held in contact with the support surface 45s. The upper resonator element 42j and the passageway wall 45w of the duct element 41 are integrally fitted and combined with each other with the abutment surface 42t and support surface 45s being held in contact with each other. Each of the lower end of the upper resonator element 42j and the upper end of the lower resonator element 42k has a welding surface 42y. The lower resonator element 42k and upper resonator element 42j are welded together at their surfaces 42y thereof.

The second resonator 42 is formed with a cavity which is held in communication with the air intake passageway 45t of the passageway portion 45 so that the noises generated by the oscillation of the intake air passing through the air intake passageway 45t can be reduced with the noises resonated in harmony within the cavity.

Referring to FIGS. 4, 10 and 11, the inner air intake duct member 23 includes a first duct element 51, a second duct element 52, and a duct element connecting portion 53 adapted to integrally connect the first and second duct elements 51 and 52. The first and second duct element 51, 52, and the duct element connecting portion 53 can be made of a plastic material, and thus produced, for example, through a molding such as an injection molding, a blow molding, or the like to form an integral structure.

The first duct element 51 has an inlet portion 54 allowing air to be introduced therethrough, a coupling portion 55 to be coupled with the air cleaner 106, and a passageway portion 56 extending between the inlet portion 54 and the coupling portion 55 to pass the intake air from the inlet portion 54 to the coupling portion 55.

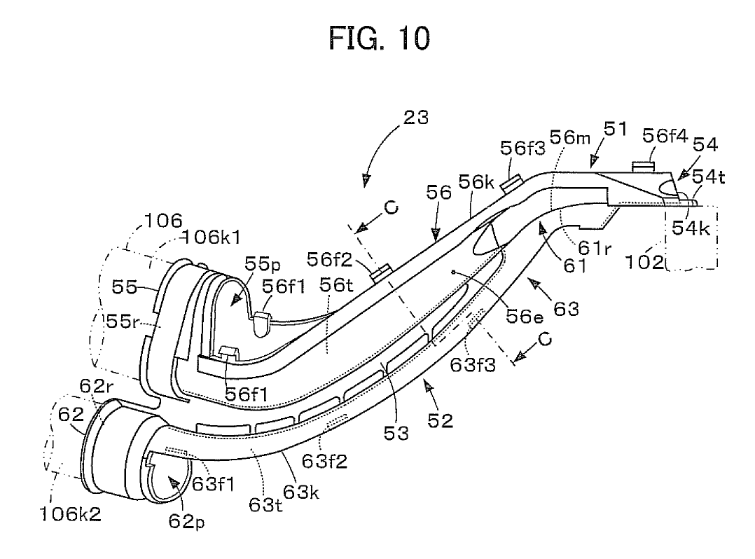

The inlet portion 54, as best shown in FIGS. 4 and 10, has an inlet port 54k opened in a direction perpendicular to the direction along which the air flows, the air being introduced into the passageway portion 56 from the inlet port 54k. The inlet portion 54 also includes, as best shown in FIG. 4, a reinforcing protrusion 54r formed so as to protrude toward the duct element 31 from the bottom surface 54m of the inlet portion 54. The protrusion 54r is adapted to reinforce the bending strength of the first outer air intake duct member 21 so as not to be dented when the first outer air intake duct member 21 is forced to be pressurized toward the duct element 31.

Attachment members 54t, as shown in FIGS. 1, 3, 4 and 10, are provided on both sides of the inlet portion 54, respectively. Each of the attachment member 54t has a hole 54h formed therein. Bolts 104 and 105 are inserted into the holes 54h, respectively.

As best shown in FIG. 10, the coupling portion 55 has communication ports 55r and 55p. The communication port 55r is opened in the direction perpendicular to the direction along which the intake air flows, and is held in communication with an air intake passageway 106k1 of the air cleaner 106. The communication port 55p is held in communication with the air intake passageway 35t of the first outer air intake duct member 21 so that the intake air can pass to the air intake passageway 106k1 of the air cleaner 106 through the communication ports 55r and 55p.

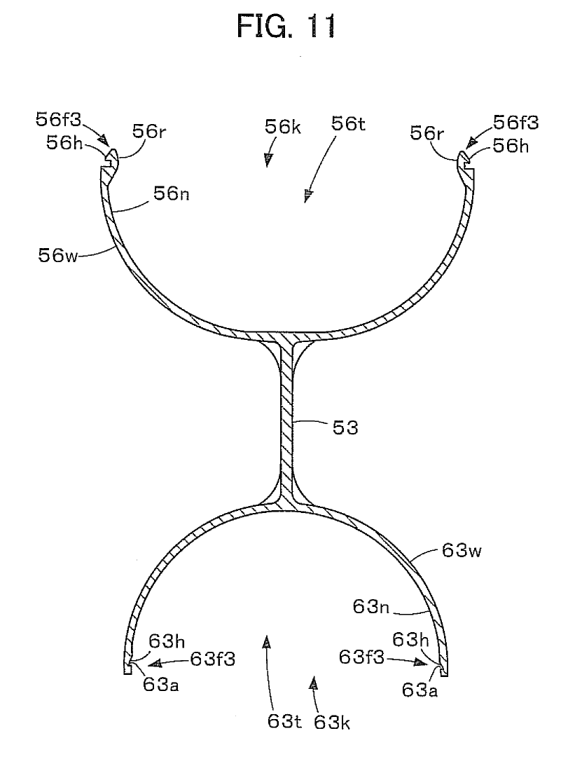

The passageway portion 56 has a third opening 56k upwardly opened and an air intake passageway 56t formed therein, the third opening 56k extending in the longitudinal direction of the first air intake duct 24, viz., in the direction along which the intake air flows therein. The air intake passageway 56t, as shown in FIG. 11, is formed by a passageway wall 56w of the duct element 51 having a cross section in a roughly arcuate shape in the plane perpendicular to the direction along which the intake air flows. In the air intake passageway 56t, the inflow port 54k of the inflow portion 54 is held in communication with the communication port 55p of the coupling portion 55. While the passageway wall 56w is explained to have a cross section in a roughly arcuate shape, it may have any cross section having a shape formed by part of square or other polygonal shapes according to the present invention.

On the inner wall portion of the passageway wall 56w in the vicinity of the third opening 56k, there are provided a plurality of pairs of hooks 56f1, 56f2, 56f3, and 56f4 in a spaced relationship with one another at a certain interval in the direction along which the intake air flows. The hooks of each pair are opposed to each other with the third opening 56k being interposed therebetween. It is noted that the respective hooks 56f1, 56f2, 56f3, and 56f4 constitute the first fastening device in the present invention together with the respective pairs of hooks 35f1, 35f2, 35f3, and 35f4 of the passageway wall 35w.

As best shown in FIG. 11, each of the hooks 56f3 has a bulge 56r protruded inwardly, viz., toward the opening 56k from the inner wall portion 56n of the passageway wall 56w, and an eave-like ledge 56h protruded and integrally formed with the bulge 56r. Each of the hooks 56f1 and 56f2 is formed similarly to the hook 56f3.

The passageway wall 56 is formed with an inflow opening 56m in the vicinity of the inlet portion 54 so that the air introduced from the inlet portion 54 can flow from the inflow opening 56m to the second air intake duct 25 through an inflow portion 61. The inflow portion 61 will be described hereinafter.

The passageway wall 56w, as best shown in FIGS. 4 and 10, has a bulge 56e protruded outwardly from the side thereof so that the air intake duct structure 20 has a high stiffness. Therefore, the swing range of the air intake duct structure 20 swung by the vibrations generated in an automotive vehicle can be suppressed due to its high stiffness. As a result, the space around the air intake duct 20, e.g., the space between the air intake duct structure 20 and the upper radiator hose 112 can be made small in comparison with the conventional air intake duct structure. In this way, the distance between the air intake duct structure 20 and the components near thereto can become smaller so that the space around the air intake duct structure 20 can be reduced.

The second duct element 52 has the inflow portion 61 allowing the intake to be introduced from the first duct element 51, a coupling portion 62 to be coupled with the air cleaner 106, and a passageway portion 63 extending between the inflow portion 61 and the coupling portion 62 for passing the intake air from the inflow portion 61 to the coupling portion 62

The inflow portion 61, as best shown in FIG. 10, has an inflow port 61r opened in the direction perpendicular to the direction along which the intake air flows so that the intake air can be introduced from the inflow port 61r into the passageway portion 63.

The coupling portion 62 has communication ports 62r and 62p. The communication port 62r is opened in the direction perpendicular to the direction along which the intake air flows, and is held in communication with an air intake passageway 106k2 of the air cleaner 106. The communication port 62p is held in communication with the air intake passageway 45t of the second outer air intake duct member 22. The intake air passes to the air intake passageway 106k2 of the air cleaner 106 through the communication ports 62r and 62p.

The passageway portion 63 has a fourth opening 63k downwardly opened and an air intake passageway 63t formed therein, the fourth opening 63k extending in the longitudinal direction of the second air intake duct 25, viz., in the direction along which the intake air flows therein. The air intake passageway 63t, as shown in FIG. 11, is formed by a passageway wall 63w of the duct element 52 having a cross section in a roughly arcuate shape in the plane perpendicular to the direction along which the intake air flows. In the air intake passageway 63t, the inflow port 61r of the inflow portion 61 is held in communication with the communication port 62p of the coupling portion 62. While the passageway wall 63w is explained to have a cross section in a roughly arcuate shape, it may have any cross section having a shape formed by part of square or other polygonal shapes according to the present invention.

On the inner wall portion of the passageway wall 63w in the vicinity of the fourth opening 63k, there are provided a plurality of pairs of hooks 63f1, 63f2, and 63f3 in a spaced relationship with one another at a certain interval in a direction along which the intake air flows. The hooks of each pair are opposed to each other with the fourth opening 63k being opposed therebetween. It is noted that the respective hooks 63f1, 63f2, and 63f3 constitute part of the second fastening device in the present invention. In other words, the respective hooks 63f1, 63f2, and 63f3 and the respective hooks 45f1, 45f2, 45f3, and 45f4 of the passageway wall 45w collectively constitute the second fastening device in the present invention.

As best shown in FIG. 11, each of the hooks 56f3 has a notch 63h dented from the inner wall portion 63n of the passageway wall 63w and a jaw-like ledge 63a formed next to the notch 63h. Each of the hooks 63f1 and 63f2 is formed similarly to the hook 63f3.

The duct element connecting portion 53 comprises a connecting member for connecting the duct elements 52 and 53, which is extended between the passageway wall 56w of the passageway portion 56 and the passageway wall 63w of the passageway portion 63 and in the longitudinal direction of the passageway portions 56 and 63. One end of the connecting member 53 in a vertical direction in FIG. 11 is connected to the passageway wall 56w, while the other end in a vertical direction in FIG. 11 is connected to the passageway wall 63w. In other words, the first duct element 51, the second duct element 52, and the duct element connecting portion 53 are integrally formed.

Subsequently, there will be described the operation of fastening the first outer air intake duct member 21 and the second outer air intake duct member 22 to the inner air intake duct member 23 in the air intake duct structure 20.

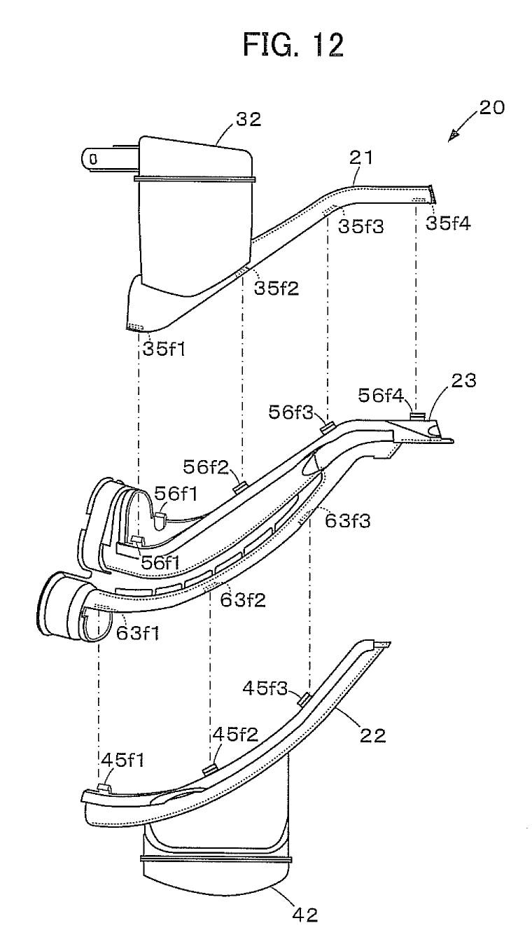

Referring to FIG. 12, the hooks 35f1, 35f2, 35f3, and 35f4 of the first outer air intake duct member 21 are engaged with the hook 56f1, 56f2, 56f3, and 56f4 of the inner air intake duct member 23, respectively, to fasten the air intake duct members 21 and 23 together.

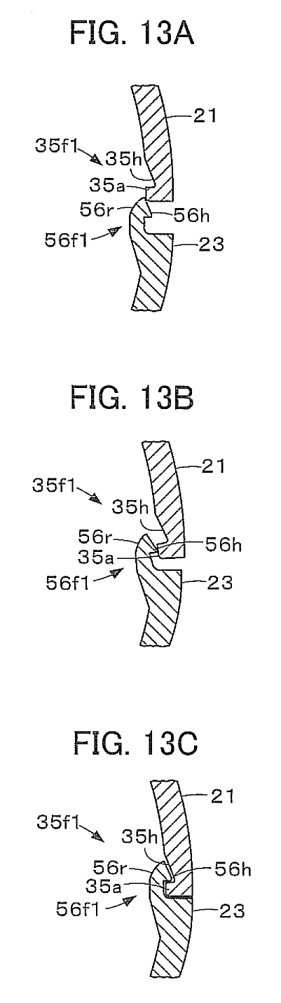

In FIGS. 13A, 13B and 13C, there will be described about more detail of the engagement of the hooks 35f1 and 56f1. As shown in FIG. 13A, the lower portion of the jaw-like ledge 35a of the hook 35f1 is forced to be engaged with the upper portion of the eave-like ledge 56h of the hook 56f1. At this time, the hooks 35f1 and 56f1 are elastically deformed because the hooks are made of elastomeric plastic as shown in FIG. 13B. The jaw-like ledge 35a of the hook 35f1 is then engaged and coupled with the eave-like ledge 56h of the hook 56f1 as shown in FIG. 13C. In this manner, the ledges 35a and 56h are firmly engaged to each other while retaining respective inner stresses therein.

The hooks 35f2 and 35f3 are firmly engaged with the hooks 56f2 and 56f3, respectively, similarly to the hooks 35f1 and 56f1.

The hooks 45f1, 45f2, and 45f3 of the second outer air intake duct member 22 are also engaged with the hook 63f1, 63f2, and 63f3 of the inner air intake duct member 23, respectively, to fasten the air intake duct members 22 and 23 together.

The operation of the air intake duct structure 20 according to the first embodiment will now be explained.

As can be seen in FIG. 5, air is introduced from the inlet port 20p constituted by the inlet port 33k of the first outer air intake duct member 21 and the inlet port 54k of the inner air intake duct member 23. The introduced air or intake air passes through the first air intake duct 24, and then is discharged from the communication port 55r to the air intake passageway 106k1 of the air cleaner 106.

On the other hand, the intake air introduced from the inlet port 20p flows into the second air intake duct 25 through the inflow port 61r, and then passes through the second air intake duct 25. Finally, the intake air is discharged from the communication port 62r to the air intake passageway 106k1 of the air cleaner 106.

At this time, the noises can be reduced by the first resonator 32 and the second resonator 42 even if noises are generated by the intake air passing through the first air intake duct 24 and the second air intake duct 25.

As the air intake duct structure 20 according to the first embodiment is constructed as described hereinbefore, the following advantageous effects can be obtained.

From the foregoing description, it will be understood that according to the first embodiment, the air intake duct structure 20 comprises the first outer air intake duct member 21, the second outer air intake duct member 22, and the inner air intake duct member 23 juxtaposed between the first outer air intake duct member 21 and the second outer air intake duct member 22. The first and second outer air intake duct members 21 and 22 are fastened with the inner air intake duct member 23 by the hooks 35f1, 56f1, etc. constituting the first fastening device and the hooks 45f1, 63f1, etc. constituting the second fastening device, respectively.

This means that the first and second outer air intake duct members 21 and 22 are fastened with the inner air intake duct member 23 to construct an integrally assembled air intake duct structure, so that the air intake duct structure thus integrally assembled can obtain a high stiffness in comparison with the conventional assembly structure constituted by separate air intake ducts with an elastic material like sponge being interposed therebetween.

Therefore, as shown in FIGS. 1 and 2, the air intake duct structure 20 having the high stiffness can be securely mounted on the engine 100 only by coupling one end portion of the air intake duct 20 to the air cleaner 106 and by attaching the other end portion to the radiator support 102 with bolts 104 and 105.

Also, the first outer air intake duct member 21, the second outer air intake duct member 22, and the inner air intake duct member 23 are separately constituted, so that these components can easily be produced through not only a conventional blow molding but also an injection molding. The injection molding is most useful in ensuring a mass productivity, resulting in an enhanced production efficiency when a number of air intake duct structures are manufactured.

While respective end portions of separate air intake ducts in the conventional dual-type air intake duct structure are attached to the radiator support by bolts, the air intake duct structure 20 can be securely mounted on the engine 100 by attaching only one end portion thereof to the radiator support by bolts according to the present invention. This means that the number of bolts used for attaching the air intake duct structure 20 to the radiator support can be decreased in comparison with the conventional dual-type air intake duct structure. Furthermore, the sponge member used in the conventional dual-type air intake duct structure can be omitted in the air intake duct structure 20 according to the present invention, because the inner air intake duct member 23 is integrally formed. As a result, the air intake duct structure 20 according to the present invention can realize an excellent workability of the assembling operation and an enhanced production efficiency in comparison with the conventional dual-type air intake duct structure.

Because the air intake duct structure 20 has the high stiffness, the swing range of the air intake duct structure swung due to the vibrations generated in an automotive vehicle is reduced to a degree as small as possible. As a result, no wider space in an engine room is required for the air intake duct structure.

The explanation of the air intake duct structure 20 according to the first embodiment has been directed to the case wherein the first and second outer air intake duct members 21 and 22 include the coupling portions 55 and 62 at the air discharge side thereof, respectively, the coupling portions 55 and 62 being coupled to the coupling portions 55 and 62 of the inner air intake duct member, respectively.

However, each of the first and second outer air intake duct members may not be provided with the coupling portion, and the above mentioned air intake duct member may not be provided with the coupling portions of the inner air intake duct member according to the present invention as will be seen from the following description.

The upper portion of the inner air intake duct member may have a lower air discharge portion formed at the air discharge side thereof and the first outer air intake duct member may have an upper air discharge portion formed at the air discharge side thereof according to the present invention. The lower and upper air discharge portions collectively constitute an outlet portion having an outlet passageway allowing the intake air to be discharged when the first outer air intake duct member and the inner air intake duct member are fastened by means of the first fastening device. The outlet passageway of the outlet portion is held in communication with the air intake passageway of the air cleaner so that the air discharged from the outlet portion can flow into the air intake passageway of the air cleaner.

Similarly to the above case, viz., the lower and upper air discharge portions collectively constituting the outlet portion, another outlet portion may be formed at the air discharge sides of the second outer air intake duct member and the inner air intake duct member as described below.

The lower portion of the inner air intake duct member may have an upper air discharge portion formed at the air discharge side thereof and the second outer air intake duct member may have an lower air discharge portion formed at the air discharge side thereof according to the present invention. The upper and lower air discharge portions collectively constitute an outlet portion having an outlet passageway allowing the intake air to be discharged when the first outer air intake duct member and the inner air intake duct member are fastened by means of the second fastening device. The outlet passageway of the outlet portion is held in communication with the air intake passageway of the air cleaner so that the air discharged from the outlet portion can flow into the air intake passageway of the air cleaner.

The explanation of the air intake duct structure 20 according to the first embodiment has also been directed to the case wherein the attachment members 54t are provided in the vicinity of the inlet portion 54 of the inner air intake duct member 23.

However, the attachment members may be provided in the vicinity of any member other than the inner air intake duct member. For example, the attachment members can be provided in the vicinity of the inlet portion of the first or second outer air intake duct member.

The explanation of the air intake duct structure 20 according to the first embodiment has also been directed to the case wherein the air intake duct structure is constituted by the first and second air intake ducts 24 and 25, and thus the intake air flows into the air cleaner 106 through the first and second air intake ducts.

However, one of the first and second air intake ducts 24 and 25 may be provided with an opening/closing valve to open or close the passageway thereof, and an actuator may be further provided to actuate the opening/closing valve. The actuator may be operated by an electronic control unit (ECU) to control the amount of air introduced to the engine by adjusting the flow rate of the intake air through the passageway while actuating the opening/closing valve depending on the driving condition of the engine.

The explanation of the air intake duct structure 20 according to the first embodiment has also been directed to the case wherein the first fastening device is constituted by the hooks 35f1, 35f2, 35f3, 35f4, 56f1, 56f2, 56f3, and 56f4 formed on the respective inner wall portions of the passageway walls 35w and 56w of the first outer air intake duct member 21 and the inner air intake duct member 23, while the second fastening device is constituted by the hooks 45f1, 45f2, 45f3, 63f1, 63f2, and 63f3 formed on the respective inner wall portions of the passageway walls 45w and 63w of the second outer air intake duct member 22 and the inner air intake duct member 23.

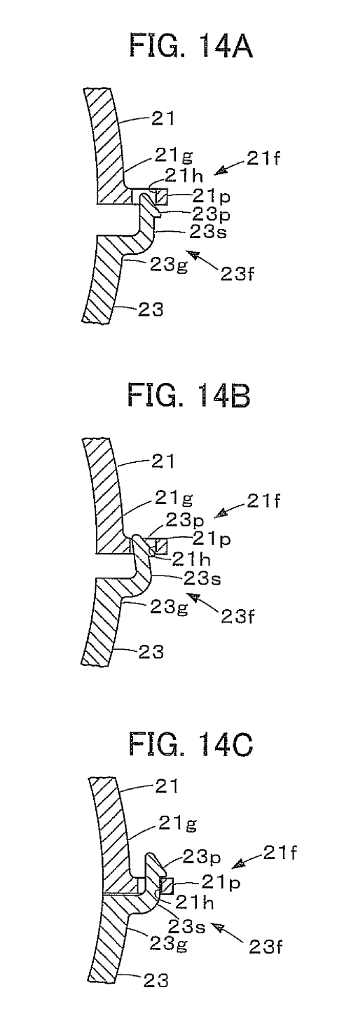

However, the first and second fastening devices may be constituted by hooks different from the above hooks in their shapes and positions to be formed on. For example, on the respective outer wall portions of the passageway walls of the first outer air intake duct member 21 and the inner air intake duct member 23, there may be formed hooks 21f and 23f as shown in FIGS. 14A, 14B, and 14C

The hook 21f has an engagement portion 21p protruded from the lower outer portion 21g of the passageway wall of the first outer air intake duct member 21, the first engagement portion 21p having an engagement hole 21h formed therein. The hook 23f has an engagement portion 23p protruded from the upper outer portion 23g of the passageway wall of the inner air intake duct member 23, and a supporting portion 23s to support the engagement portion 23p thereon.

The hooks 21f and 23f thus formed are engaged to each other as will be seen from the following description. As best shown in FIG. 14 A, the engagement portion 21p of the hook 21f is forced to be engaged with the engagement portion 23p of the hook 23f. The engagement portion 23p of the hook 23f passes through the engagement hole 21h as shown in FIG. 14B. The engagement portion 23p of the hook 23f is then engaged and coupled with the engagement portion 21p as shown in FIG. 14C. As each of the hooks 21f and 23f is made of elastomeric plastic, the engagement portions 21p and 23p thereof are firmly engaged to each other.

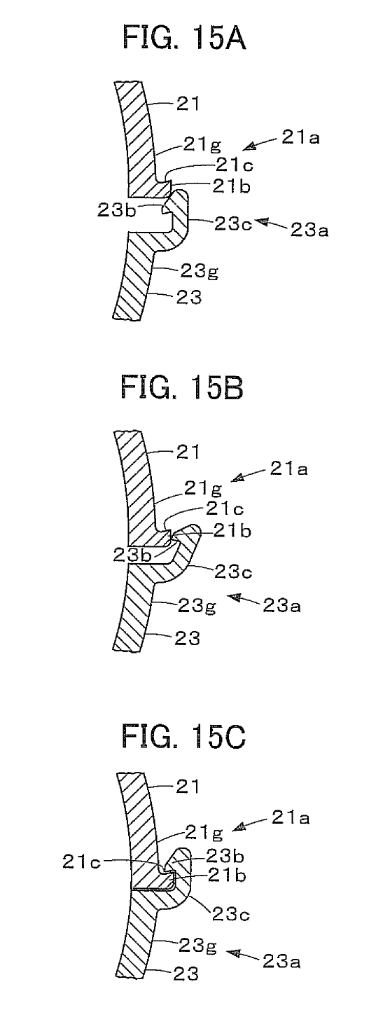

Also, on the outer wall portions of the passageway walls of the first outer air intake duct member 21 and the inner air intake duct member 23, there may be formed hooks as can be seen in FIGS. 15A, 15B and 15C.

The hook 21a has an engagement portion 21b protruded from the lower outer wall portion 21g of the passageway wall of the first outer air intake duct member 21, the engagement portion 21b having a ledge portion 21c. On the other hand, the hook 23a has an engagement portion 23b and a supporting portion 23c to support the engagement portion 23b thereon, the supporting portion 23c being protruded from the upper outer wall portion 23g of the passageway wall of the inner air intake duct member 23.

The hooks 21a and 23a thus formed are engaged to each other as will be seen from the following description. The engagement portion 21b of the hook 21a is forced to be engaged with the engagement portion 23b of the hook 23b as shown in FIG. 15A. At this time, the hooks 21a and 23a are elastically deformed because the hook 21a and 23a are made of elastomeric plastic as shown in FIG. 15B. The engagement portion 23b is then engaged and coupled with the engagement portion 21b as shown in FIG. 15C. In this manner, the engagement portion 21b and the engagement portion 23b are firmly engaged and coupled to each other.

The explanation of the air intake duct structure 20 according to the first embodiment has been directed to the case wherein four pairs of hooks are provided to constitute the first fastening device, and three pairs of hooks are provided to constitute the second fastening device. However, any number of pairs of hooks may be provided to constitute the first and second fastening devices. For example, one, two, three or more than four pairs of hooks may be provided as the first fastening device. Also, one, two, or more than three pairs of hooks may be provided as the second fastening device.

### Second Embodiment

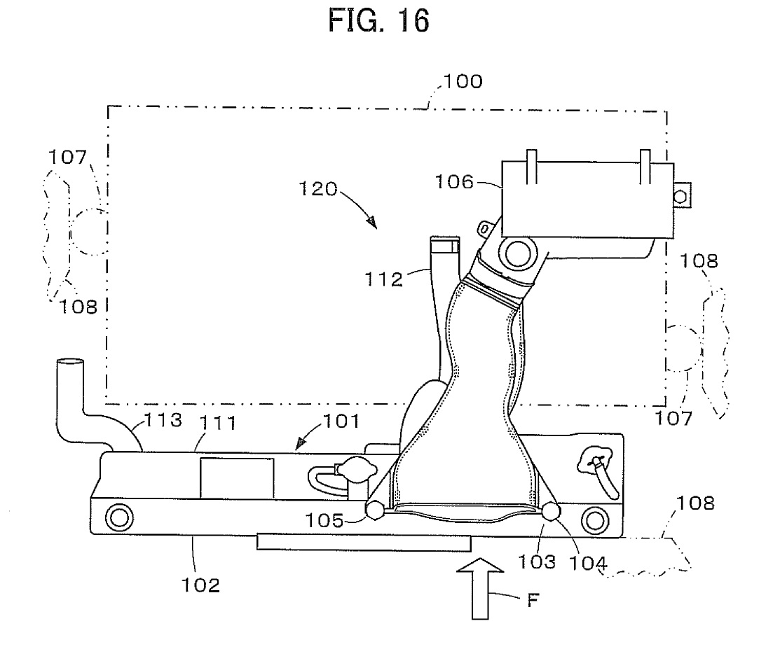

An air intake duct structure 120 according to the second embodiment of the present invention will now be described with reference to FIGS. 16 to 25. The air intake duct structure 120 has the same structure as that in the first embodiment except that a first and a second outer air intake duct members are different from those in the first embodiment. Therefore, the same reference numerals are used for the same components in the second embodiment as those in the first embodiment shown in FIGS. 1 to 15. Hereinafter, the second embodiment will be explained for the differences with respect to the first embodiment.

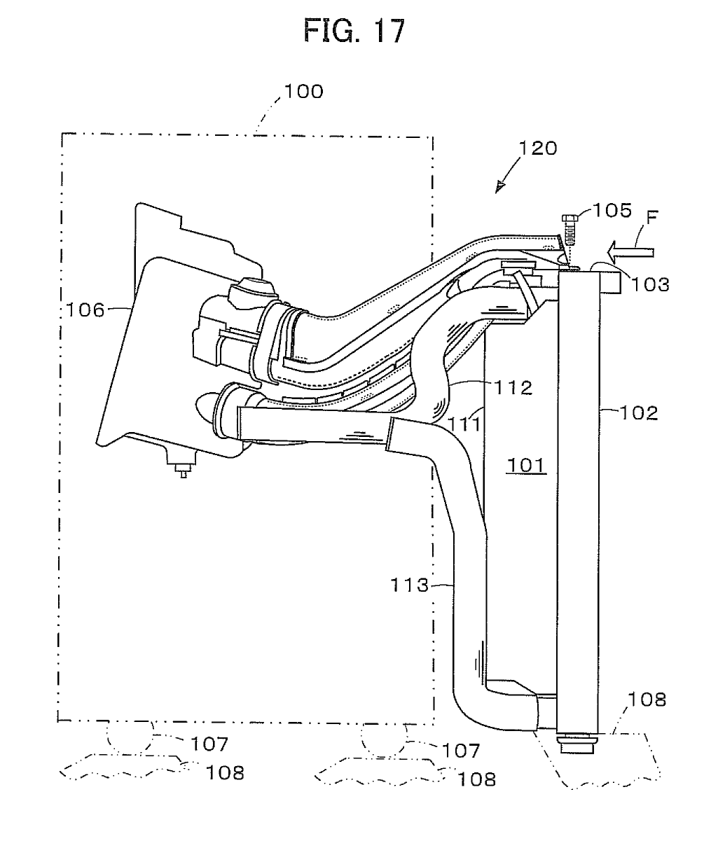

The structure of the air intake duct structure 120 according to the second embodiment will now be explained. Referring to FIGS. 16 and 17, in the same way as the air intake duct structure 20 according to the first embodiment, the air intake duct structure 120 is attached at one end portion by the bolts 104 and 105 to the upper portion 103 of the radiator support 102 which supports the radiator 101 on the engine 100, and coupled at the other end portion to the air cleaner 106.

The air intake duct structure 120 thus constructed can introduce comparatively cool air to the engine 100 through the air cleaner 106 in the direction as indicated by an arrow F in FIG. 17.

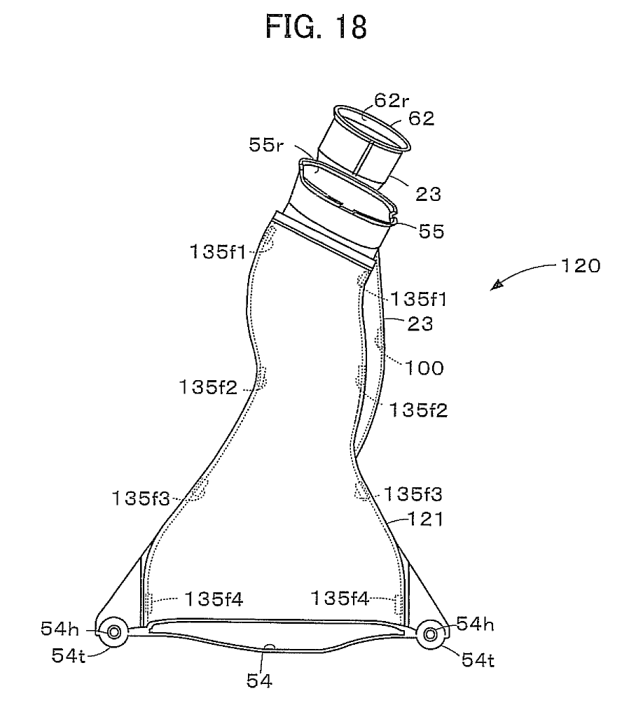

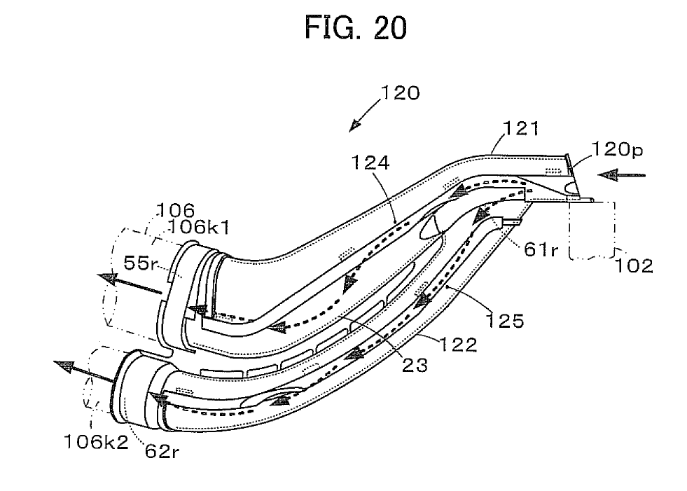

In FIGS. 18 to 20, the air intake duct structure 120 comprises a first outer air intake duct member 121, a second outer air intake duct member 122, and an inner air intake duct member 23. The first outer air intake duct member 121 and the upper portion of the inner air intake duct member 23 are connected with each other to constitute a first air intake duct 124, while the second outer air intake duct member 122 and the lower portion of the inner air intake duct member 23 are also connected with each other to constitute a second air intake duct 125. The intake air is divided into the air intake ducts 124 and 125 as shown by the arrows and dotted lines in FIG. 20 when the intake air is introduced into the duct structure 120.

As best shown in FIGS. 18, 21 and 22, the first outer air intake duct member 121 can be made of a plastic material, and thus produced, for example, through a molding such as an injection molding, a blow molding, or the like using.

The first outer air intake duct member 121 has an inlet portion 133 allowing air to be introduced therethrough, a coupling portion 134 to be coupled to the inner air intake duct member 23, and a passageway portion 135 extending between the inlet portion 133 and the coupling portion 134 to pass the intake air from the inlet portion 133 to the coupling portion 134.

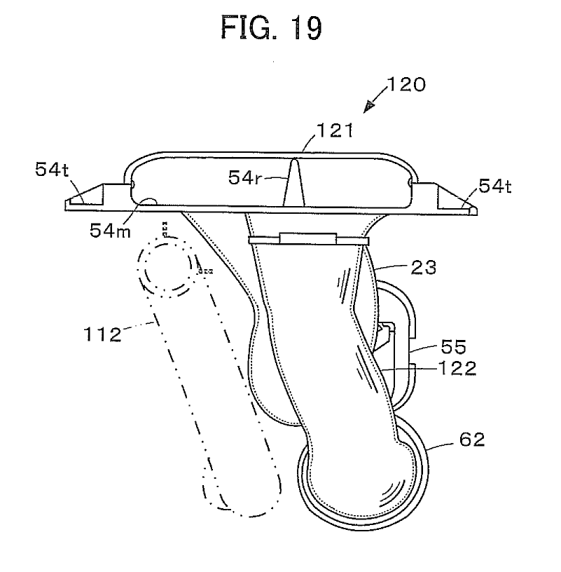

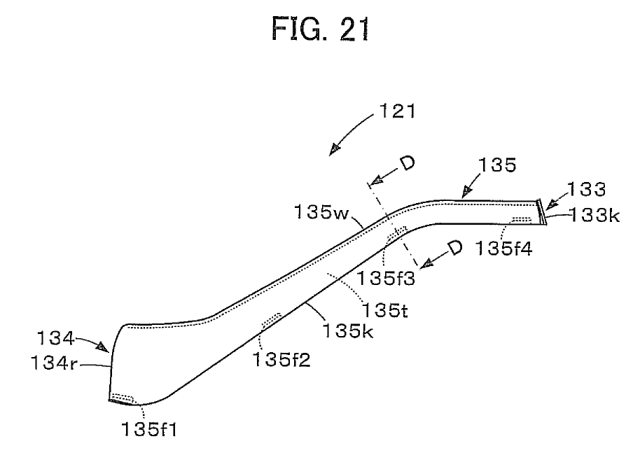

The inlet portion 133, as shown in FIGS. 19 and 21, has an inlet port 133k opened in a direction perpendicular to the direction along which the intake air flows. The intake air is introduced from the inlet port 133k into the passageway portion 135.

The coupling portion 134, as shown in FIG. 21, has a communication port 134r opened in a direction perpendicular to the direction along which the intake air flows. The intake air passes through the communication port 134r to the air cleaner 106.

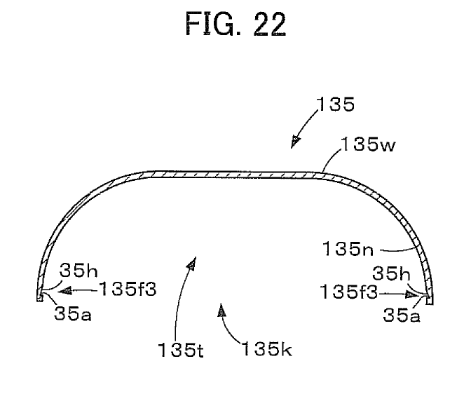

The passageway portion 135 has a first opening 135k downwardly opened and an air intake passageway 135t formed therein, the first opening 135k extending in the longitudinal direction of the first air intake duct 124, viz., in the direction along which the intake air flows therein. As shown in FIG. 22, the air intake passageway 135t is formed by a passageway wall 135w having a cross section in a roughly arcuate shape in the plane perpendicular to the direction along which the intake air flows. In the air intake passageway 135t, the inlet port 133k of the inlet portion 133 is held in communication with the communication port 134r of the coupling portion 134, as shown in FIG. 21. While the passageway wall 135w is explained to have a cross section in a roughly arcuate shape, it may have any cross section having a shape formed by part of square or other polygonal shapes according to the present invention.

On the opposite longitudinal end portions of the passageway wall 135w in the vicinity of the first opening 135k, there are provided a plurality of pairs of hooks 135f1, 135f2, 135f3, and 135f4 in the same way as the pairs of hooks 35f1, 35f2, 35f3, and 35f4 in the first embodiment. The pairs of hooks are positioned at a certain interval in the direction along which the intake air flows. The hooks of each pair are opposed to each other with the first opening 135k being interposed therebetween. It is noted that the respective pairs of hooks 135f1, 135f2, 135f3, and 135f4 constitute part of the first fastening device in the present invention.

Referring to FIGS. 19, 23 and 24, the second outer air intake duct member 122 is made of a plastic material, and thus produced, for example, through a molding such as an injection molding, a blow molding, or the like similarly to the first outer air intake duct member 121.

The second air intake duct member 122 has an inflow portion 143 allowing the intake air to be introduced therethrough, a coupling portion 144 to be coupled to the inner air intake duct member 23, and a passageway portion 145 extending between the inflow portion 143 and the coupling portion 144 to pass the intake air from the inflow portion 143 to the coupling portion 144.

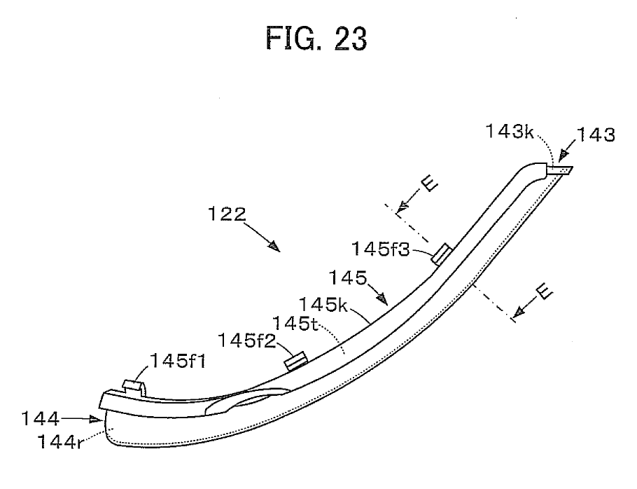

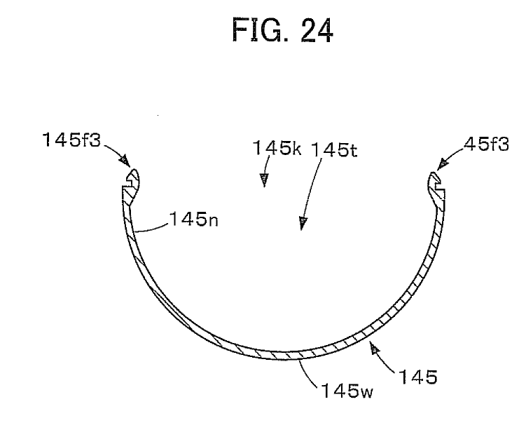

As best shown in FIGS. 23 and 24, the inflow portion 143 has an inflow port 143k opened in the direction perpendicular to the direction along which the intake air flows, so that the intake air can flow from the inlet port 143k into the passageway portion 145.

As best shown in FIG. 23, the coupling portion 144 has a communication port 144r opened in the direction perpendicular to the direction along which the air flows. The intake air passes through the communication port 144r to the air cleaner 106.

The passageway portion 145 has a second opening 145k upwardly opened and an air intake passageway 145t formed therein, the second opening 145k extending in the longitudinal direction of the second air intake duct 125, viz., in the direction along which the intake air flows. As shown in FIG. 24, the air intake passageway 145t is formed by a passageway wall 145w of the passageway portion 145 having a cross section in a roughly arcuate shape in the plane perpendicular to the direction along which the intake air flows. In the air intake passageway 145t, the inflow port 143k of the inflow portion 143 is held in communication with the communication port 144r of the coupling portion 144. While the passageway wall 145w is explained to have a cross section in a roughly arcuate shape area, it may have any cross section having a shape formed by part of square or other polygonal shapes according to the present invention.

On the opposite longitudinal end portions of the passageway wall 145w in the vicinity of the second opening 145k, there are provided a plurality of pairs of hooks 145f1, 145f2, and 145f3 in the same way as the pairs of hooks 45f1, 45f2, and 45f3 in the first embodiment. The pairs of hooks are positioned at a certain interval in the direction along which the intake air flows. The hooks of each pair are opposed to each other with the second opening 145k being interposed therebetween. The respective hooks 145f1, 145f2, and 145f3 constitute part of the second fastening device in the present invention.

Subsequently, there will be described the operation of fastening the first outer air intake duct member 121 and the second outer air intake duct member 122 to the inner air intake duct member 23 in the air intake duct structure 120.

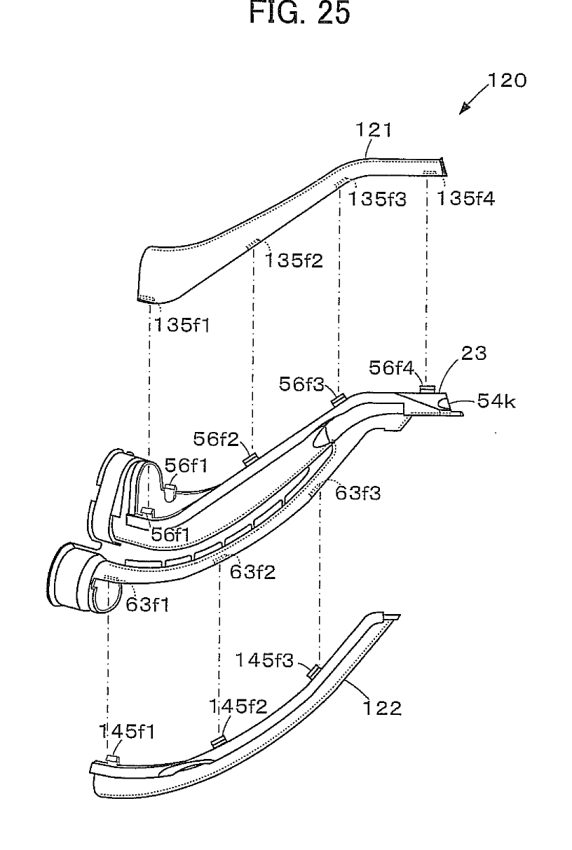

In FIG. 25, the hooks 135f1, 135f2, 135f3, and 135f4 of the first outer air intake duct member 121 are engaged with the hook 56f1, 56f2, 56f3, and 56f4 of the inner air intake duct member 23, respectively, to fasten the intake duct members 121 and 23 together.

The hooks 145f1, 145f2, and 145f3 of the second outer air intake duct member 122 are also engaged with the hook 63f1, 63f2, and 63f3 of the inner air intake duct member 23, respectively, to fasten the intake duct members 122 and 23 together.

The operation of the air intake duct structure 120 according to the second embodiment will now be explained.

As best shown FIG. 20, air is introduced from the inlet port 120p combined by the inlet port 133k of the first outer air intake duct member 121 and the inlet port 54k of the inner air intake duct member 23. The intake air passes through the first air intake duct 124, and then is discharged from the communication port 55r to the air intake passageway 106k1 of the air cleaner 106.

On the other hand, the intake air introduced from the inlet port 120p flows into the second air intake duct 125 through the inflow port 61r, and then passes through the second air intake duct 125. Finally, the intake air is discharged from the communication port 62r to the air intake passageway 106k2 of the air cleaner 106.

As the air intake duct structure 120 according to the second embodiment is constructed as described hereinbefore, the following advantageous effects can be obtained.

From the foregoing description, it will be understood that according to the second embodiment, the air intake duct structure 120 comprises the first outer air intake duct member 121, the second outer air intake duct member 122, and the inner air intake duct member 23 juxtaposed between the first outer air intake duct member 121 and the second outer air intake duct member 122. The first and second outer air intake duct members 121 and 122 are fastened with the inner air intake duct member 23 by the first fastening device and the second fastening device, respectively as has been described in the above.

This means that the first and second outer air intake duct members 121 and 122 are fastened with the inner air intake duct member 23 to form an integrally assembled air intake duct structure, so that the high stiffness can be realized in comparison with the conventional assembly structure constituted by separating both of the air intake ducts with a sponge material interposed therebetween.

Therefore, the air intake duct structure 120 having the higher stiffness than that of a conventional air intake duct structure, as shown in FIGS. 16 and 17, can be mounted on the engine 100 only by coupling one end portion of the air intake duct structure 120 to the air cleaner 106 and by attaching the other end portion thereof to the radiator support 102 with bolts 104 and 105.

While respective end portions of separate air intake ducts in the conventional dual-type air intake duct structure are attached to the radiator support by bolts, the air intake duct structure 120 can be securely mounted on the engine 100 by attaching only one end portion thereof to the radiator support by bolts. This means that the number of bolts used for attaching the air intake duct structure 120 to the radiator support can be decreased in comparison with the conventional dual-type air intake duct structure, Therefore, the workability of fastening operation becomes improved and then the production efficiency is enhanced.

Because the air intake duct structure 120 has the high stiffness, the swing range of the air intake duct structure swung due to the vibrations generated in an automotive vehicle is reduced to a degree as small as possible. As a result, no wider space in an engine room is required for the air intake duct structure according to the present invention.

As described above, the present invention can provide the air intake duct structure having advantageous effects such as the reduction in the number of components, the excellent workability of assembling operation, the enhanced production efficiency, and the high stiffness thereof. It will be appreciated that the present invention is applicable to an air intake duct structure having a plurality of air ducts arranged to be juxtaposed with each other.

What is claimed is:

1. An air intake duct structure for passing intake air therethrough, comprising:
a first outer air intake duct member having a first opening formed therein to extend in the longitudinal direction of the first outer air intake duct member;
a second outer air intake duct member having a second opening formed therein to extend in the longitudinal direction of the second outer air intake duct member;
an inner air intake duct member having third and fourth openings both formed therein to extend in the longitudinal direction of the inner air intake duct member, the inner air intake duct member being juxtaposed between the first and second outer air intake duct members in such a manner that the third opening of the inner air intake duct member is opposed to the first opening of the first outer air intake duct member, and the fourth opening of the inner air intake duct member is opposed to the second opening of the second outer air intake duct member;
a first fastening device for fastening the first outer air intake duct member with the inner air intake duct member; and
a second fastening device for fastening the second outer air intake duct member with the inner air intake duct member;
wherein the first and second outer air intake duct members are fastened with the inner air intake duct member, respectively, by the first and second fastening device to form first and second air intake ducts allowing the intake air to pass therethrough.

2. An air intake duct structure according to claim 1, wherein
the first outer air intake duct member includes a first passageway wall forming the first opening in the longitudinal direction of the first outer air intake duct,
the second outer air intake duct member includes a second passageway wall forming the second opening in the longitudinal direction of the second outer air intake duct member,
the inner air intake duct member includes a third passageway wall forming the third opening in the longitudinal direction of the inner air intake duct member and a fourth passageway wall forming the fourth opening in the longitudinal direction of the inner air intake duct member,
the first fastening device is provided on the first and third passageway walls, and
the second fastening device is provided on the second and fourth passageway walls.

3. An air intake duct structure according to claim 2, wherein
the first fastening device is constituted by a plurality of hooks formed on the outer wall portion of the first passageway wall and a plurality of hooks formed on the outer wall portion of the third passageway wall,
the second fastening device is constituted by a plurality of hooks formed on the outer wall portion of the second passageway wall and a plurality of hooks formed on the outer wall portion of the fourth passageway wall,
the hooks of the first passageway wall are respectively engaged with the hooks of the third passageway wall to fasten the first outer air intake duct member with the inner air intake duct member, and
the hooks of the second passageway wall are respectively engaged with the hooks of the fourth passageway wall to fasten the second outer air intake duct member with the inner air intake duct member.

4. An air intake duct structure according to claim 2, wherein
the first fastening device is constituted by a plurality of hooks formed on the inner wall portion of the first passageway wall and a plurality of hooks formed on the inner wall portion of the third passageway wall,
the second fastening device is constituted by a plurality of hooks formed on the inner wall portion of the second passageway wall and a plurality of hooks formed on the inner wall portion of the fourth passageway wall,
the hooks of the first passageway wall are respectively engaged with the hooks of the third passageway wall to fasten the first outer air intake duct member with the inner air intake duct member, and
the hooks of the second passageway wall are respectively engaged with the hooks of the fourth passageway wall to fasten the second outer air intake duct member with the inner air intake duct member.

5. An air intake duct structure according to claim 3 or 4, wherein
the first air intake duct is formed to have an inlet port allowing the intake air to be introduced therethrough, an inflow opening formed in the third passageway wall in the vicinity of the inlet port, and a first outlet port allowing the intake air to be discharged therethrough, and
the second air intake duct is formed to have an inflow port communicated to the inflow opening, and a second outlet port allowing the intake air to be discharged to the second air intake duct from the first air intake duct through the inflow opening and inflow port.

6. An air intake duct structure according to claim 5, wherein
one of the first outer air intake duct member, the second outer air intake duct member, and the inner air intake duct member is provided with an attachment member arranged in the vicinity of the inlet port.

7. An air intake duct structure according to claim 6, wherein
the first outer air intake duct member includes a first resonator mounted on the outer wall portion of the first passageway wall for reducing intake noises generated in the first intake duct, and
the second outer air intake duct member includes a second resonator mounted on the outer wall portion of the second passageway wall for reducing intake noises generated in the second intake duct.
